(19) United States
(12) Patent Application Publication
(10) Pub. No.: US 2006/0059511 A1
(43) Pub. Date: Mar. 16, 2006

(54) System and method for media content distribution

(75) Inventors: Alexander D. Nocifera, Redondo Beach, CA (US); Claude Ciocan, Anaheim, CA (US)

Correspondence Address: R. Lee Fraley;Snell & Wilmer L.L.P., One Arizona Center, 400 East Van Buren, Phoenix, AZ, 85004-2202, US

(73) Assignee: ActiveMaps, Inc.

(21) Appl. No.: 11/227,656

(22) Filed: Sep. 14, 2005

Related U.S. Application Data
(60) Provisional application No. 60/609,710, filed on Sep. 14, 2004.

(51) Int. Cl. H04N 7/10; H04N 5/445; H04N 7/173

(52) U.S. Cl. 725/32; 725/109; 725/110; 725/120; 725/42

(57) ABSTRACT

A media and content distribution system and method are provided, wherein specific media and content, including advertising material, real time traffic, news, sports, weather, and financial stock and/or other like information is delivered via cellular or other wireless network technology to locally distributed display panels, such as large plasma and LCD screens, positioned in high traffic or viewing areas. In addition, an exemplary media and content distribution system can include a highly complex scheduling and rotating capability that enables multiple media files to display at multiple locations based on each individual display requirement for advertising, training, entertainment, and other purposes. An exemplary media and content distribution system comprises a Global Scheduling System (GSS) and a Regional Content Delivery System (RCDS) configured to communicate through a communications network such as the Internet. Content and media can suitably be delivered from the Regional Content Delivery System to a Remote Display Unit (RDU) through cellular or other wireless network. The Remote Display Unit can suitably “poll” the Regional Content Delivery System to receive data and information, and then proceed to store the data and information locally to suitably reduce network utilization.

### CROSS-REFERENCE TO RELATED APPLICATIONS

This application claims priority to and benefit of U.S. Provisional Application No. 60/609,710, entitled “System and Method for Media Content Distribution” and filed on Sep. 14, 2004.

### TECHNICAL FIELD

The present invention relates, generally, to communication networks, and in particular to a system and method for media content distribution for digital signage networks and applications.

### BACKGROUND OF THE INVENTION

One of the biggest problems with current digital signage networks is the investment of both financial resources and time to install the network infrastructure to support the underlying product. Most current digital signage technologies require the establishment of a LAN-based network. Setting up such a LAN-based network requires extensive capital for both the installation and maintenance of the network itself (cabling, routing, etc.) and the supporting server-based infrastructure. Even with the needed capital, many prime digital signage locations are not conducive to the installation of such items. Even wireless networks today mostly consist of 802.11 Networks, which still require the installation and maintenance of a LAN-based infrastructure to support the 802.11 Network.

### SUMMARY OF THE INVENTION

In accordance with various aspects of the present invention, a media and content distribution system and method are provided, wherein specific media and content, including advertising material, real time traffic, news, sports, weather, and financial stock and/or other like information is delivered via cellular or other wireless network technology to locally distributed display panels, such as large plasma and LCD screens, positioned in high traffic or viewing areas. In addition, an exemplary media and content distribution system can include a highly complex scheduling and rotating capability that enables multiple media files to display at multiple locations based on each individual display requirement for advertising, training, entertainment, and other purposes.

In accordance with an exemplary embodiment, a media and content distribution system comprises a Global Scheduling System (GSS) and a Regional Content Delivery System (RCDS) configured to communicate through a communications network such as the Internet. Content and media can suitably be delivered from the Regional Content Delivery System to a Remote Display Unit (RDU) through cellular or other wireless network. The Remote Display Unit can suitably “poll” the Regional Content Delivery System to receive data and information, and then proceed to store the data and information locally to suitably reduce network utilization. Accordingly, selected data, content and information can be provided at each Remote Display Unit depending on the requests or intentions of advertisers, data providers and/or local remote display users and viewers.

### BRIEF DESCRIPTION OF THE DRAWINGS

The exemplary embodiments of the present invention will be described in connection with the appended drawing figures in which like numerals denote like elements.

FIG. 1 illustrates a diagram of an exemplary media content distribution system in accordance with an exemplary embodiment of the present invention;

FIGS. 2A and 2B illustrates a logic diagram of an exemplary method of RDU data transport in accordance with an exemplary embodiment of the present invention;

FIG. 3 illustrates a diagram of an exemplary cellular/wireless network in accordance with an exemplary embodiment of the present invention;

FIG. 4 illustrates an exemplary configuration of a screen layout for an RDU in accordance with an exemplary embodiment of the present invention;

FIG. 5 illustrates an exemplary screen image in accordance with an exemplary embodiment of the present invention; and

FIG. 6 illustrates a sample advertising layout in accordance with an exemplary embodiment of the present invention.

### DETAILED DESCRIPTION

The present invention may be described herein in terms of various components and processing steps. It should be appreciated that such components and steps may be realized by any number of hardware and software components configured to perform the specified functions. For example, the present invention may employ various electronic control devices, visual display devices, input terminals and the like, which may carry out a variety of functions under the control of one or more control systems, microprocessors or other control devices. In addition, the present invention may be practiced in any number of communication contexts and the exemplary embodiments relating to a system and method for media content distribution for digital signage networks and applications as described herein are merely a few of the exemplary applications for the invention. For example, the principles, features and methods discussed may be applied to any communications application.

In accordance with various aspects of the present invention, a media and content distribution system and method are provided, wherein specific media and content, including advertising material, real time traffic, news, sports, weather, and financial stock and/or other like information is delivered via cellular or other wireless network technology to locally distributed display panels, such as large plasma and LCD screens, positioned in high traffic or viewing areas. In addition, a media and content distribution system can include a highly complex scheduling and rotating capability that enables multiple media files to display at multiple locations based on each individual display requirement for advertising, training, entertainment, and other purposes.

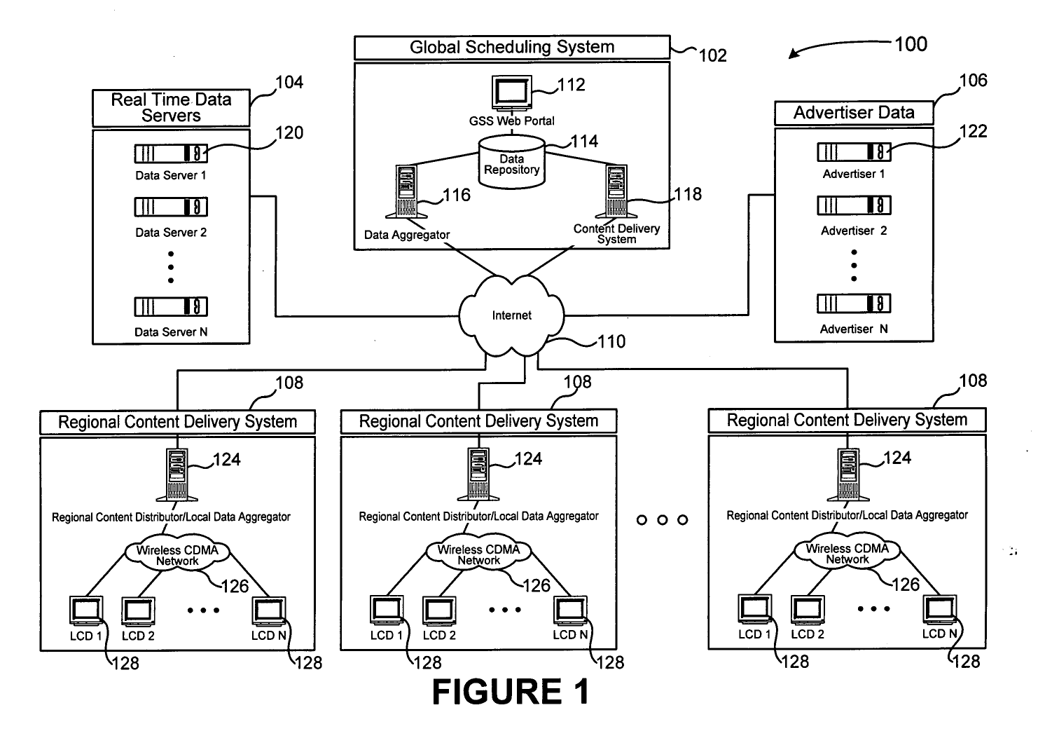

In accordance with an exemplary embodiment, with reference to FIG. 1, an exemplary media and content distribution system 100 comprises a Global Scheduling System (GSS) 102 and one or more Regional Content Delivery Systems (RCDS) 108 configured to communicate through a communications network such as the Internet network 110. Internet network 110 can comprise any configuration of network for allowing communications between global scheduling system 102 and RCDS 108.

Global scheduling system 102 is configured for collection of data and content and to provide such data and content to Regional Content Delivery Systems 108. In accordance with an exemplary embodiment, global scheduling system 102 comprises a data aggregator 116 to collect real time data and graphical content from disparate systems, a data repository 114 to store all of the content, a web portal 112 to manage and schedule the content, and a content delivery system 118 to push out the content and scheduling information to a selected regional content delivery system 108.

Data aggregator 116 communicates with numerous real time content providers and periodically updates data repository 114 with current data. The data supplied by the different content providers will vary and therefore the data aggregator will normalize the data and store it in a common format. Such data and advertising content can be acquired from various sources, such as from real time servers 104 and/or advertising data sources 106. Data aggregator 116 can also gather and store the media files necessary to display the content.

Web portal 112 is configured to authorize users to schedule real time media delivery to individual remote display units (RDUs). Content can be altered and rescheduled easily and a complete log of historical data can be stored in data repository 114.

Content delivery system 118 is configured to periodically poll data repository 114 for changes in content and schedules and then transmit the appropriate data to the selected regional content delivery systems 108.

Regional Content Delivery Systems (RCDSs) 108 are configured to serve as an intermediary between the client-side devices and global scheduling system 102. In accordance with an exemplary embodiment, each RCDS 108 comprises a regional content distributor/local data aggregator 124 configured to communicate through a cellular or wireless network 126 to one or more client side devices 128, e.g., one or more RDUs.

Regional Content Delivery System 108 is programmed to “pull” data from real-time disparate sources, including advertising data and/or real-time traffic, news, sports, weather, and/or financial information. In addition, RCDS 108 can also be configured to retrieve local real time data and local advertising media based on scheduling information from the global scheduling system 102. RCDS 108 can regularly monitor each client device for vital statistics and returns stats to data repository 114 of global scheduling system 102.

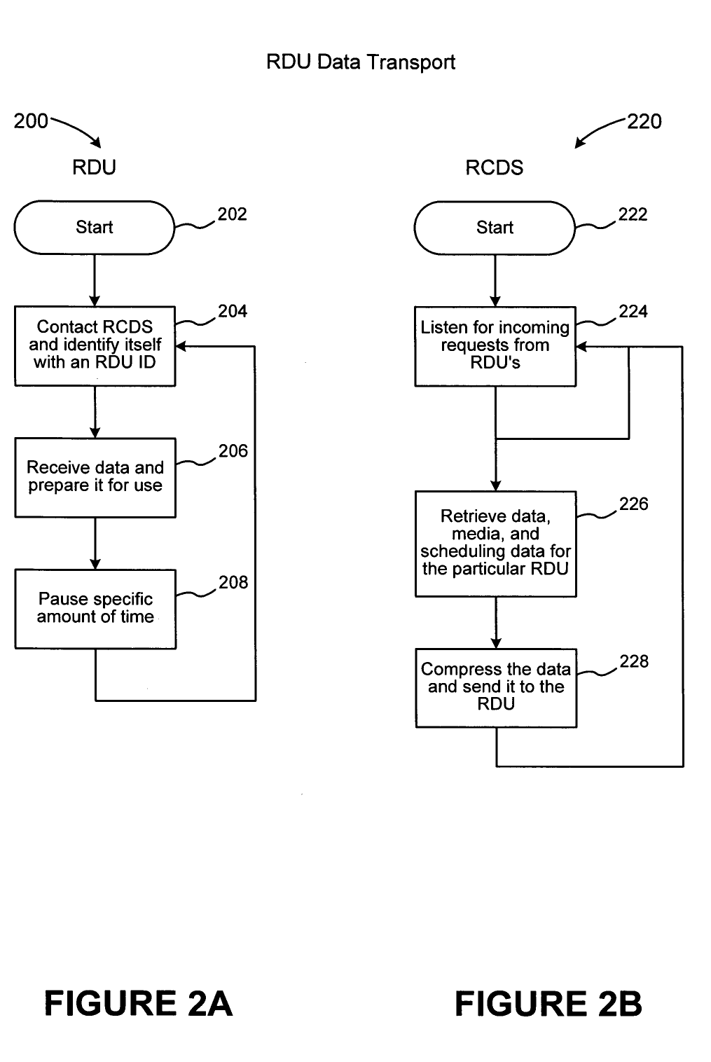

The data and content from an RCDS 108 can be provided in various manners to Remote Display Units (RDUs). For example, with reference to FIGS. 2A and 2B, at start (202) an RDU is configured to contact or “poll” an RCDS 108 and identify the certain RDU through a unique identification (204) over a wireless connection or network. The data can be transmitted via a cellular or other wireless network, such as a CDMA wireless connection, GSM, EDGE, or EVDO or other like networks, to the specific RDU. An exemplary RDU can suitably receive data and prepare for use and display for users (206). In addition, an exemplary RDU can then proceed to store the data and information locally to suitably reduce network utilization. RDU can then suitably again contact an RCDS 108 for additional or update information, such as after a pause (208). Concurrently, an exemplary RCDS can suitably start communications and data delivery (222) by listening for incoming requests from RDU's (224), and then suitably retrieve data, media and other scheduling data for the requesting RDU (226). Such data can then be transferred in various formats to the appropriate RDU, e.g., the data can be suitably compressed before sending to the RDU (228), i.e., for receipt of date and preparation for use (206). Accordingly, selected data, content and information can be provided at each RDU depending on the requests or intentions of advertisers, data providers and/or local remote display users and viewers.

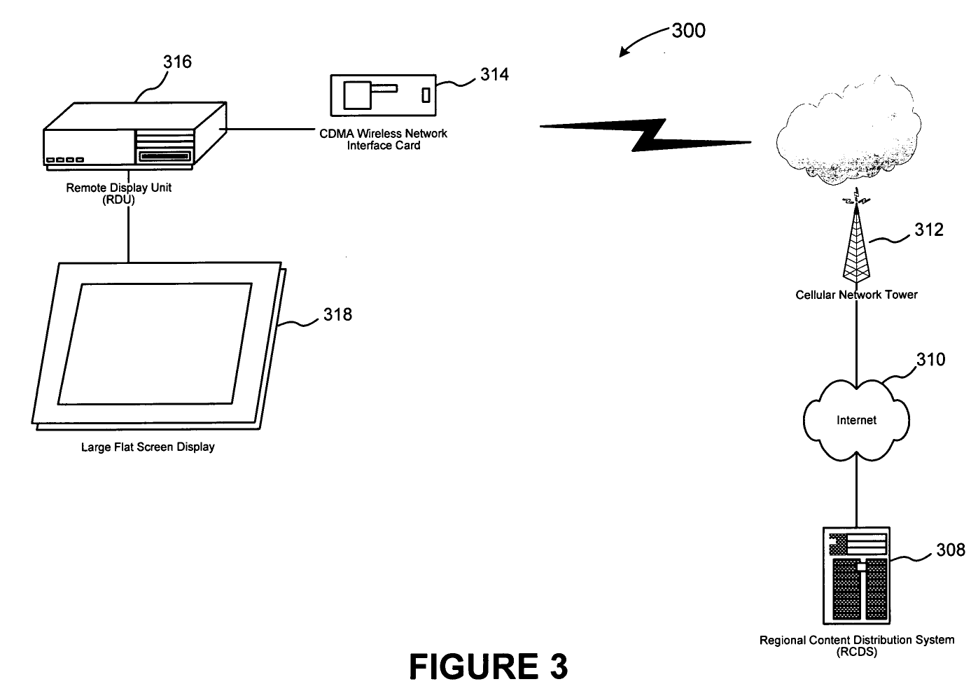

Content, data and media can suitably be delivered from the Regional Content Delivery System (RCDS) to a Remote Display Unit (RDU) through various configurations of cellular or other wireless networks. For example, with reference to FIG. 3, in accordance with an exemplary embodiment, a cellular communications network 300 can comprise an RCDS 308 coupled to a cellular network tower 312, such as through an Internet network 310 or any other suitable network. Cellular network tower 312 can comprise any system or device for facilitating cellular or wireless communications between devices.

An exemplary RDU 316 can comprise various configurations, including one or more microprocessors, memory devices or other computer components. To transmit requests and receive data, RDU 316 can suitably comprise a cellular network interface card 314. Any information, data or other content can be suitably displayed through a variety of devices, such as for example, a large flat screen display 318, or any other display device.

In addition, each RDU 316 can continue to drive local remote display 318 with the last known media, real time data, and schedule, even when the cellular network becomes unavailable. RDU 316 can also perform health checks at regular intervals and attempt to reconnect to the cellular network as soon as it becomes available.

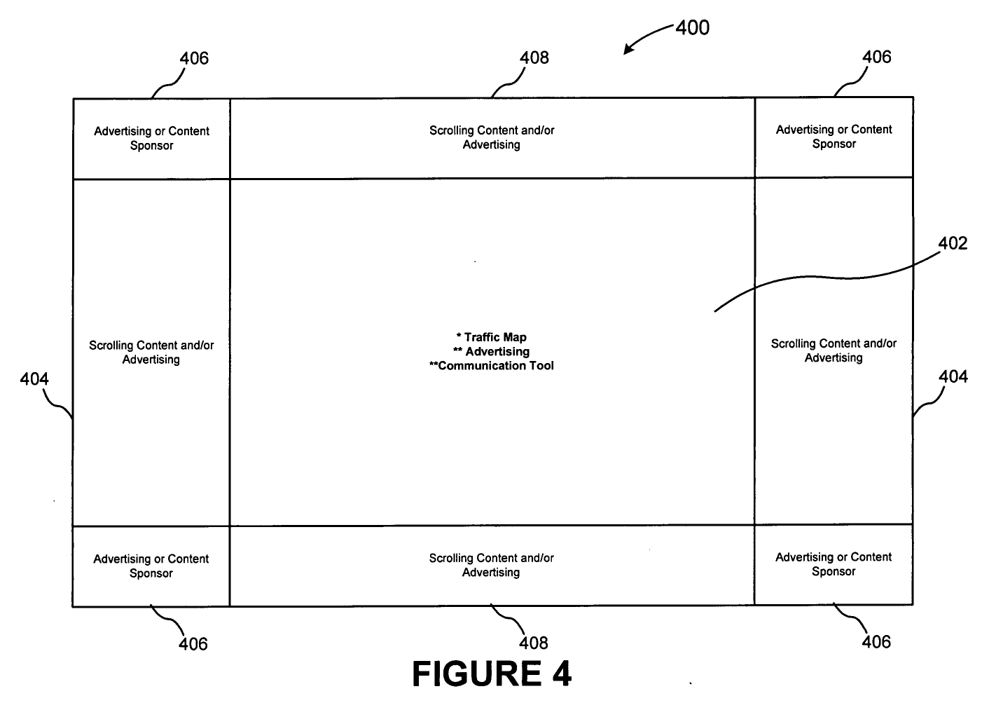

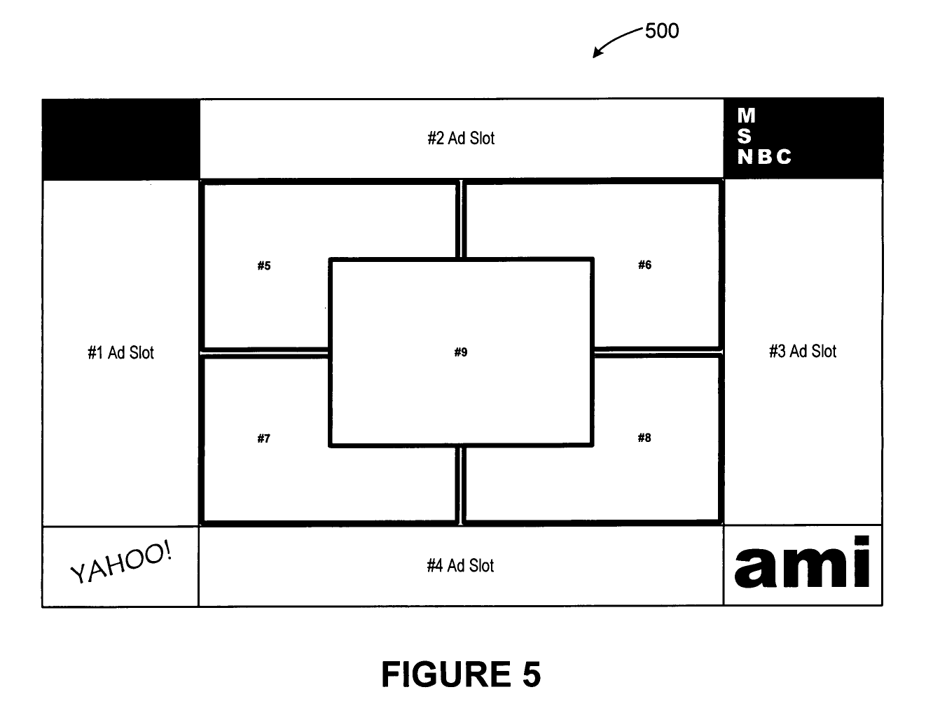

The data, content and other information can be suitably displayed by display device 318 in various formats. For example, with reference to FIG. 4, an exemplary screen layout 400 can comprise a main display area 402 that includes desired data, such as traffic, communications, advertising or any other data or content, one or more scrolling content and/or advertising regions 404 and 408, and one or more stationary advertising or content sponsor regions 406. Display area 402 can comprise a single region or two or more regions. For example, with reference to FIG. 5, a display area can comprise slot #'s 5, 6, 7, 8 and/or 9.

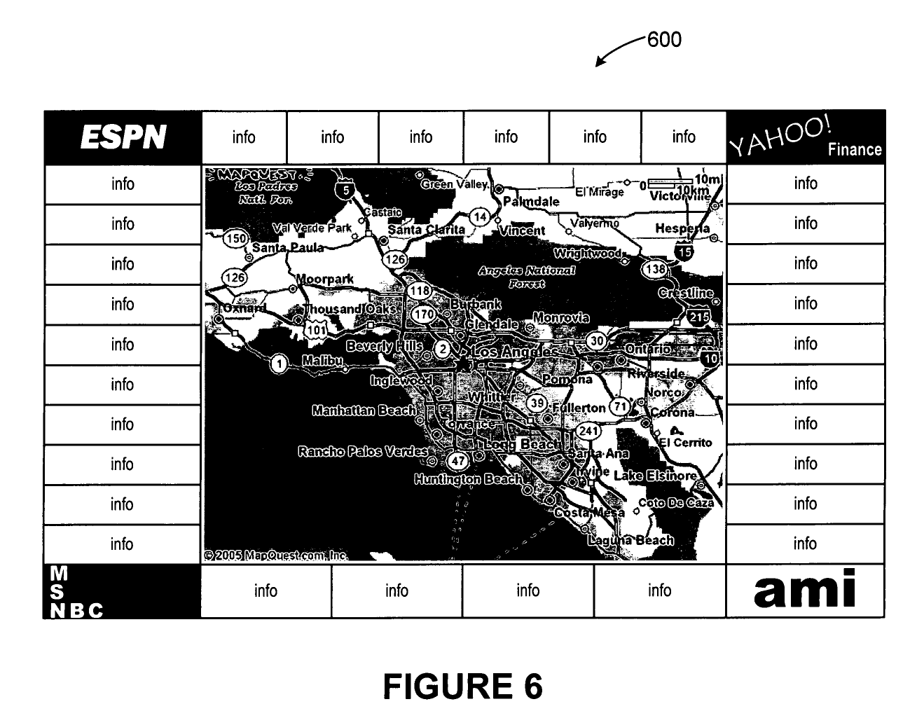

Regions 404, 406 and 408 can be suitably interchanged in any manner, can include scrolling, dynamic or static information, and can comprise various dimensions around or within display area 402. For example, with reference to FIG. 5, an exemplary screen layout 500 can comprise one or more advertising regions, e.g., #1, 2, 3 or 4 ad slots. In accordance with a further exemplary embodiment, a display screen can comprise a variety of data, such as that illustrated with reference to FIG. 6.

The present invention has been described above with reference to various exemplary embodiments. However, those skilled in the art will recognize that changes and modifications may be made to the exemplary embodiments without departing from the scope of the present invention. For example, the various operational steps, as well as the components for carrying out the operational steps, may be implemented in alternate ways depending upon the particular application or in consideration of any number of cost functions associated with the operation of the system, e.g., various of the component and methodologies and/or steps may be deleted, modified, or combined with other components, methodologies and/or steps. For example, various of the systems and devices, such as within the global scheduling system or the regional content delivery system, can suitably utilize compression algorithms to reduce network usage and/or include failure recovery mechanisms to efficiently transfer large files that are susceptible to cellular connection interruptions. Further, it should be noted that while the method and system for media content distribution for digital signage networks and applications is described above is suitable for programming and use by a user proximate the RDUs, the system can also be accessed remotely, i.e., the user can operate through a remote display having information transmitted in various manners of communication, such as by satellite/wireless or by wired connections such as IP or digital cable networks and the like. These and other changes or modifications are intended to be included within the scope of the present invention, as set forth in the following claims.

1. A media and content distribution system for delivering advertising, news and/or weather information and data, said media and content distribution system comprising:
a global scheduling system configured for collection of real-time data and content, said global scheduling system comprising:
a global data aggregator configured to collect the real-time data and content from disparate sources;
a data repository to store the real-time data and content;
a web portal to manage and schedule the real-time data and content; and
a content delivery system to push out the scheduled real-time data and content;
an Internet communications network for facilitating communications with said global scheduling system; and
a plurality of regional content delivery systems configured to pull the data and content from the real-time disparate sources, each of said regional content delivery systems communicatively coupled through said Internet communications network to said global scheduling system, and each of said regional content delivery systems comprising:
a regional content distributor/local data aggregator configured to retrieve local real-time data and content based on scheduling information from said global scheduling system;
a cellular/wireless communications network for communicating with said regional content distributor/local data aggregator; and
a plurality of remote display units communicatively coupled to said regional content distributor/local data aggregator through said cellular/wireless communications network, each of said plurality of remote display units configured to display the local real-time data and content.

2. The media and content distribution system according to claim 2, wherein the global data aggregator communicates with real-time content providers and periodically updates said data repository with real-time data and content, said global data aggregator configured to normalize the real-time data and content.

3. The media and content distribution system according to claim 2, wherein said web portal is configured to authorize users to schedule real-time media delivery to said regional content delivery systems.

4. The media and content distribution system according to claim 2, wherein said content delivery system is configured to poll said data repository for changes in content and schedules for transmission to said regional content delivery systems.

5. The media and content distribution system according to claim 2, wherein each of said plurality of regional content delivery systems is configured for retrieving local real-time data and content based on scheduling information received from said global scheduling system, and for monitoring each of said plurality of remote display units for vital statistics and returns such statistics to said data repository of said global scheduling system.

6. The media and content distribution system according to claim 2, wherein each said remote display unit is configured upon start to poll a corresponding regional content delivery system and provide identification for said remote display unit through a cellular network to said corresponding regional content delivery system, said corresponding regional content delivery system being configured to listen for said polling of said remote display unit and to retrieve and transmit the real-time scheduled data and content for transmission to said remote display unit, said remote display unit configured to prepare the real-time scheduled data and content for display to viewers.

7. The media and content distribution system according to claim 2, wherein each of said regional content delivery systems is configured to communicate through an Internet network to a cellular network tower for further transmission of real-time scheduled data and content to a cellular network interface card within each of said plurality of remote display units, wherein the real-time scheduled data and content is displayed through a flat-panel display device.

8. The media and content distribution system according to claim 7, wherein said flat-panel display device comprises a viewing display comprising a main display region, a plurality of scrolling information regions, and a plurality of advertising regions.

9. A method for media and content distribution for delivering advertising, news and/or weather information and data, said method for media and content distribution comprising:
collecting real-time data and content within a global scheduling system through a global data aggregator;
storing the real-time data and content within a data repository of said global scheduling system;
managing and scheduling the real-time data and content through a web portal of said global scheduling system;
pushing out the scheduled real-time data and content through a content delivery system of said global scheduling system;
communicating from said global scheduling system through an Internet communications to a plurality of regional content delivery systems configured to pull the data and content from the real-time disparate sources;
retrieving local real-time data and content with a regional content distributor/local data aggregator within said regional content delivery systems, said local real-time data and content based on scheduling information from said global scheduling system;
communicating from said regional content distributor/local data aggregator through a cellular/wireless communications network to a plurality of remote display units; and
displaying through each of said plurality of remote display units the local real-time data and content.
